(19) United States
(12) Patent Application Publication
(10) Pub. No.: US 2004/0136666 A1
(43) Pub. Date: Jul. 15, 2004

(54) Fiber delivery system for laser diodes

(76) Inventors: Morten Bruun-Larsen, Rodovre (DK); Olav Balle-Petersen, Humlebaek (DK)

Correspondence Address: BIRCH STEWART KOLASCH & BIRCH, PO BOX 747, FALLS CHURCH, VA, 22040-0747, US

(21) Appl. No.: 10/471,175

(22) PCT Filed: Mar. 6, 2002
(86) PCT No.: PCT/DK02/00140

(51) Int. Cl. G02B 6/04

(52) U.S. Cl. 385/115; 385/89

(57) ABSTRACT

An optical fiber delivery system comprising a number of first optical fibers, preferably in a bundle, and a second optical fiber light from a number of light sources are coupled into the second fiber via the first fibers. The emitting diameter of the first fibers is adjusted to match the core diameter and acceptance angle of the second fiber by reducing/increasing the number of emitting light sources being coupled to the first fibers. Thereby the brightness and efficiency of the light beam is preserved throughout the entire system in particular when the beam is passed from the first fibers to the second fiber, even if the power is reduced or the diameter of the second fiber is very small. Accurate knowledge of the optical beam which is eventually emitted by the second fiber is obtainable. Further, a method for delivering optical power from a number of light sources using the fiber delivery system.

### TECHNICAL FIELD

The invention relates to a delivery system for delivering an optical output from a number of laser diodes to an optical fiber.

### BACKGROUND OF THE INVENTION

In the medical field there is an increasing demand of coupling light into thin optical fibers. Often, it is desirable to couple light into places not accessible to large diameter fibers. When, for example, coupling light to parts inside of the body to be exposed to the light, such as for example tumours, blood vessels, etc., it is desirable to reduce the damage to the body as much as possible. One possible way of reducing damage upon penetration Is to minimize the diameter of the fiber coupling light Into the body.

Typically, high power multi-emitter diodes are used in the medical field to supply a high power light beam to an end user application. A multi-emitter diode produces a plurality of optical light beams, one from each emitter. A common method of delivering the plurality of optical light beams to an end user application includes coupling the plurality of optical light beams into a plurality of transport optical fibers. The input ends of the transport fibers are aligned with the laser diode emitters to receive the optical light beams and the output ends of the transport fibers are then, for example, bundled into a tightly packed circular array to minimize the spot size of the overall laser diode output exiting the transport fibers. The output ends of the bundle of transport fibers are then coupled to a laser delivery fiber having a predetermined diameter.

The brightness or radiance of the bundle of transport fibers, that Is, the emitted power per unit area per unit solid angle, defines the specifications for the laser delivery fiber.

Thus, if a laser delivery fiber having a diameter and a numerical aperture which do not match the diameter and the numerical aperture of the bundle of transport fibers is chosen, at least a part of the optical output emitted from the transport fibers will be lost and not coupled to the delivery fiber. The diameter of a delivery fiber having a diameter smaller than the spot size of the overall laser diode output exiting the transport fibers may thus be chosen, but the amount of power coupled into the delivery fiber will be unknown.

In U.S. Pat. No. 5,852,692, another method of reducing the diameter of the delivery fiber has been proposed. U.S. Pat. No. 5,852,692 discloses a method for tapering the output ends of the transport fibers so that the output ends may be bundled even tighter whereby the overall diameter of the bundle of transport fibers are reduced so that the diameter of the delivery fiber may be reduced correspondingly.

The tapering of the plurality of transport fibers in order to minimize the size of the bundle of transport fibers is a demanding process and only a certain reduction in the delivery fiber diameter may be obtained.

In Kawai, et al., ‘skew-Free Optical Interconnections Using Fiber Image Guides for Petabit-per-Second Computer Networks’, Jpn. J. Appl. Phys., Vol. 37 (1998), pp. 3754-3758 there is disclosed a Fiber Image Guide consisting of many individual optical fibers which are bundled together. The Fiber Image Guide is connected to a vertical-cavity surface-emitting laser (VCSEL), so that light from the VCSEL is coupled into the Fiber Image Guide and transported via the individual fibers. At the output end of the Fiber Image Guide the light may be coupled into a Large-Core Fiber Array in order to avoid alignment problems. Neither the diameter, nor the power of the output beam are controllable or adjustable. In particular, it is not possible to select a number of individual fibers to emit light, while the remaining fibers do not emit light.

In EP 0 339 991 there is disclosed a fiber bundle. Light from a single light source is coupled into an input end of the fiber bundle. At the output end of the fiber bundle, light Is coupled into another fiber. In order to ensure a uniform light distribution in the second fiber, the individual fibers of the bundle are randomly distributed across the input end as well as across the output end of the fiber bundle. Since the individual fibers are not connected to individual light sources, it is not possible to control or adjust the diameter of the light beam being coupled into the second fiber.

In U.S. Pat. No. 5,862,278 there is disclosed a bundle of single-mode fibers in which each fiber is coupled to a laser radiation source. At the output end of the fiber bundle there is positioned an optical transformation means for transforming the emitted beam into an object, such that a focal point with a highest possible power per area and per solid angle can be generated. The transformation means comprises a collimating element which collimates the laser radiation exiting divergently from each Individual output end of the single-mode fibers. The transformation means further comprises a focusing element which images the collimated radiation bundle as a whole onto a focal point. It is a disadvantage that the beam is collimated since this may cause power to be absorbed in the system, e.g. in the form of heat dissipated in the collimating element. Furthermore, the total power of the transformed beam is not accurately known since it is not known how much power is absorbed in the system, and how much power is allowed through the collimating element.

It is also a disadvantage that the beam is focused since this may cause the brightness of the beam to decrease, and furthermore may introduce losses due to the high divergence caused by the focusing.

### SUMMARY OF THE INVENTION

It is an object of the present Invention to provide a flexible fiber delivery system for coupling of light between one or more light sources and a delivery fiber.

It is a further object of the present invention to provide a fiber delivery system wherein the diameter of the delivery fiber may be chosen independently.

It is a still further object of the present invention to provide a fiber delivery system, wherein the optical power may be adapted to correspond to the chosen delivery fiber diameter.

It is a still further object of the present invention to provide a fiber delivery system which may be adapted to be used in connection with a variety of fibers having a variety of fiber diameters.

It is a still further object of the present invention to provide a fiber delivery system which is capable of at least substantially conserving the brightness and the efficiency of the emitted optical output.

According to a first aspect of the invention, the above-mentioned and other objects are fulfilled by an optical fiber delivery system comprising

a number of light sources each being adapted to produce an optical light source output,

a number of first optical fibers (transport fibers) each having an input end and an output end, the input ends being adapted to be coupled to each of the number of light sources to receive the respective optical light source output, the output ends being adapted to emit an optical output, and the first optical fibers being arranged in a spatial distribution, at least at the output ends of the first optical fibers, so as to define an emitting diameter of the first optical fibers, said emitting diameter being adjustable by means of the number of first optical fibers being coupled to each of the number of light sources producing an optical output, so as to allow said emitting diameter to be adjusted to match a core diameter and an acceptance angle of a second optical fiber,

a second optical fiber (delivery fiber) having an input end and an output end, the input end of the second optical fiber being positioned so as to receive the optical output from the number of first optical fibers, and having a core diameter and acceptance cone to which the emitting diameter of the first optical fibers may be adjusted,

wherein each of the number of first optical fibers corresponds to a specific light source, so that reduction/increase of the number of light sources producing an optical output reduces/increases the number of first optical fibers emitting an optical output so that the emitting diameter of the first optical fibers is reduced/increased so as to be adjusted to match the core diameter and acceptance cone of the second optical fiber.

In this way, by reduction of the number of first optical fibers producing an optical output, the power provided through the second optical fiber will be controllably reduced and further the diameter of the second optical fiber may be reduced to suit specific applications. By increasing the number of first optical fibers producing an optical output, an increased power output may be obtained, and thereby a fiber having a larger diameter may be required. By letting the emitting diameter of the first optical fibers match the core diameter and acceptance angle of the second fiber, it is ensured that the brightness of the emitted optical output is at least substantially conserved throughout the entire system. Thus, using the optical fiber delivery system of the present invention it is possible to reduce the fiber diameter without loosing efficiency or brightness. Only the total power of the emitted optical output is reduced. Therefore, accurate knowledge of the optical beam which is emitted by the second optical fiber is obtainable.

According to a second aspect of the invention, there is provided a method for delivering optical power from a number of light sources adapted to emit an optical light source output through a number of first optical fibers to a second optical fiber, the method comprising

connecting an input end of each of a number of first optical fibers to each of the number of light sources to couple the optical light source output Into a respective first optical fiber, thereby defining an emitting diameter of the first optical fibers,

bundle the number of first optical fibers in a predetermined fiber pattern,

choosing a core diameter and an acceptance angle of the second optical fiber,

choosing a number of light sources to emit an optical light source output so that specific first optical fibers located at specific positions in the fiber pattern receive an optical light source output, thereby adjusting the emitting diameter of the first optical fibers to match the chosen core diameter and acceptance angle of the second optical fiber.

In a variety of applications, it may be acceptable to reduce the power output of the second optical fiber in order to achieve a reduced diameter of the second optical fiber. It is an advantage of the present invention that the reduction in power may be regulated so that the power reduction may be well-known and well-controlled.

When coupling an optical output from the bundle of first optical fibers to the second optical fiber, the product of the diameter of second optical fiber and the numerical aperture of the second optical fiber is preferably substantially equal to or larger than the product of the diameter and the numerical aperture of a fiber bundle comprising the number of first optical fibers producing an optical output so that the optical output from the fiber bundle will be emitted within the acceptance cone of the second optical fiber and thus be guided in the second optical fiber. The coupling loss is hereby reduced and there is substantially no residual optical power to be absorbed in the system by, for example, applying apertures or the like to collect the residual optical power not being within the acceptance cone of the second optical fiber.

It is an advantage of the present invention that the number of light sources, such as a multi-emitter laser diode, may be adapted to be used in connection with a variety of fibers having a variety of fiber diameters. It is, thus, not necessary to obtain a number of laser apparatuses, each being dedicated for use at a specific power density and with a specific fiber.

Typically, thin fibers are advantageously used in the medical field. For example in cancer treatment, it is desirable to pass the optical fiber through the skin to treat for example subcutaneous tumours. Furthermore, during dermatological treatments, it may be desirable to close minor blood vessels, treat subcutaneous fungi, etc. These applications require the use of thin fibers to reduce the damage during introduction of the fibers into the body. Another field of application may be the treatment of glaucoma, where a thin fiber may be introduced in the cornea so that the pressure in the eye may be controlled. Furthermore, the wide use of endoscopes for treatment and diagnosis introduce an ever increasing demand for a reduced fiber thickness or fiber diameter in order to reach still more distant organs and positions in the human and/or animal body and for example introduce fibers into the coronary. In many of these applications, the demands for a thin fiber overrules the demand for a high power since many of these applications do not need as high power as for example the high power being used with ablation and other skin resurfacing procedures. There is, thus, a need for a reduced fiber diameter and in many of the application fields of the thin fibers there is a willingness to trade off high power in order to obtain a reduced fiber diameter.

It is a further advantage of the thin optical fiber that the thin fiber may be more flexible than a fiber having a larger diameter, since a smaller fiber diameter provides a decrease in the bending radius.

Typically, it has been necessary to use different lasers for high power and low power applications, respectively. It is an advantage of the present fiber delivery system that a variety of different fibers being adapted to transmit different optical power densities may be coupled to the first optical fiber bundle, the transport fibers. Hereby, the power may be transferred through the system substantially without any coupling losses or with a significantly reduced coupling loss compared to systems wherein the beam profile is reduced by submission of apertures in the light path. It is a further advantage of the fiber delivery system that the reduction of power may be predetermined and well-controlled to further ensure preservation of the brightness of the light beam. The fiber delivery system according to the present invention, thus, provides for the use of a single laser to be used at a variety of different power levels so that only a single high power laser need to be installed.

In other applications, such as skin treatment, etc., there is, as mentioned above, a need for a high power light beam having a high brightness at the point of application, and the diameter of the fiber is less important for these applications. However, even for these high power applications, different lasers emitting light at different power densities via fibers of different diameters are used. In such cases, the present invention may also be advantageously applied.

The diameter of the second optical fiber may be between 0.05 mm and 2 mm, such as for example between 0.1 mm and 2 mm, such as between 0.1 mm and 1.8 mm, such as between 0.1 mm and 1 mm, such as between 0.1 mm and 0.5 mm, or the diameter may be between 0.05 mm and 0.1 mm, 0.05 mm and 0.5 mm, 0.05 mm and 1 mm, or between 0.05 mm and 1.8 mm, such as between 0.05 and 1.5 mm. Furthermore, the diameter may be below 0.05 mm, such as between 0.001 mm and 0.045 mm.

It is envisaged that there may be more than a second optical fiber receiving the optical output from the bundle of first optical fibers. There may, for example, be provided a third, fourth, fifth, sixth, etc. optical fiber, each fiber receiving at least part of the optical output from the bundle of first optical fibers emitting an optical output.

The light sources may comprise one or more multi-emitter laser diode(s), such as one or more high-power multi-emitter laser diodes, each comprising a number of individual laser diodes producing an optical light source output, or the light sources may comprise a number of laser diodes and/or multi-emitter laser diodes arranged in stack(s) and/or bar(s). Alternatively, the light sources may comprise any number of any other light sources or laser sources comprising a number of light or laser sources.

Any number of light sources may be used. Typically, the number of light sources will be larger than 10, such as for example between 19 and 6×19, or such as between 37 and 6×37, or up to 228 or 444, or even lager than 444, such as larger than 500, such as larger than 1000.

The number of first optical fibers may be bundled in a predetermined fiber pattern so as to allow for easy tracking of first optical fibers emitting light from a specific laser diode or from one or more specific laser diode bar(s) or stack(s).

Furthermore, by knowing exactly which light source corresponds to which fiber, it is. possible to detect errors in the light sources and change the defect light source or light sources. In a preferred embodiment of the invention 6 multi-emitter laser diode bars may form a stack of laser diode bars, and it may then, for example, be possible to change only one or two defect laser diodes or laser diode bars instead of exchanging the entire laser system.

A bundle of transport fibers, for example a bundle of transport fibers receiving an optical output from a specific bar or stack of light sources may be arranged in a circle, and transport fibers receiving optical output from another bar or stack being arranged in a surrounding circle, etc., so that a fiber pattern of concentric circles is achieved. By having the fibers arranged in concentric circles, the alignment between the bundle of transport fibers and the delivery fiber is facilitated independently of the number of concentric circles, i.e. the optical power, being applied as the center of the bundle of transport fibers will remain unchanged.

### BRIEF DESCRIPTION OF THE DRAWINGS.

In the following, a preferred embodiment of a delivery system will be described with reference to the drawings, wherein

FIG. 1 shows the connection of a bundle of first optical fibers and a second optical fiber, further showing the acceptance cone of the second optical fiber,

FIG. 2 shows a number of light sources connected to a number of first optical fibers, the optical output from each of the first optical fibers corresponding to a specific light source,

FIG. 3 shows a number of groups of first optical fibers, the optical output from each group of fibers corresponding to a group of light sources, and

FIG. 4 shows a number of fiber patterns in which the number of first optical fibers may be positioned, each fiber corresponding to a single fiber or to a group of fibers receiving an optical light source output from a corresponding group of light sources.

### DETAILED DESCRIPTION OF THE DRAWINGS.

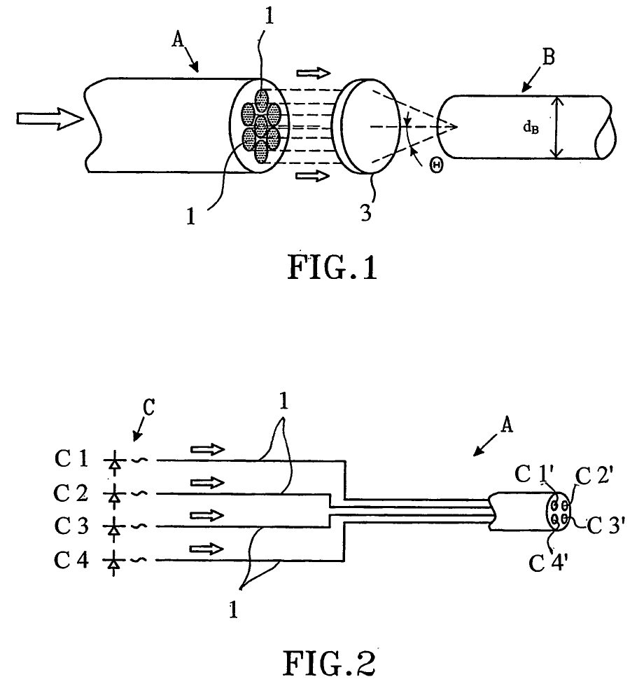

In FIG. 1, a bundle of first optical fibers, a bundle of transport fibers, A is shown guiding light from light sources (not shown) to a second optical fiber, a delivery fiber, B. The coupling between the bundle of transport fibers and the delivery fiber is accomplished via coupling optics 3. The individual transport fibers 1 are shown in the fiber bundle A. Furthermore, the acceptance cone of the delivery fiber B is shown. The acceptance cone being determined by the numerical aperture, i.e. sin θ, and the diameter d_{B} of the delivery fiber.

In the present embodiment, the emitted power and the diameter of the bundle of transport fibers is concurrently reduced in a controlled manner so that the brightness of the light coupled into the delivery fiber is the same as the brightness of the light emitted from the bundle of transport fibers even though the delivery fiber diameter is reduced. The light emitted from the bundle of transport fibers A is, thus, coupled to the delivery fiber B with substantially no loss. The product of the numerical aperture and the diameter of the delivery fiber B may also be chosen to be larger than the product of the numerical aperture and the diameter of the bundle of transport fibers A and still ensure a low loss coupling from the transport fibers 1 to the delivery fiber B.

In FIG. 2, a number of light emitting diodes, C1-C4 are shown. The light emitted from each diode is guided through transport fibers 1 which are bundled in a bundle A, the fibers 1 being bundled in a specific fiber pattern, for example in a quadrangular fiber pattern as shown in FIG. 2. According to the position of the individual transport fibers 1 in the fiber pattern, the optical output of each fiber 1 may be traced back to a specific light emitting diode C1-C4. Thus, the output from the fiber C1′ is known to correspond to the light emitting diode C1, the output from the fiber C2′ is known to correspond to light emitting diode C2, etc.

It is, hereby, possible to trace the output of each fiber back to a specific light emitting diode. This facilitates, for example, error tracing and replacement of only the defect light emitting diode(s).

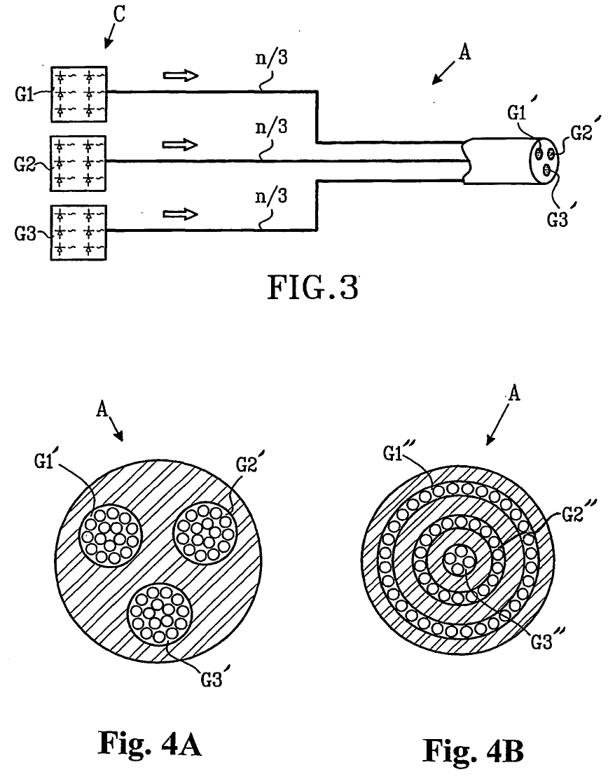

It is further possible to group a number of light emitting diodes, for example according to the bar, stack, etc. to which the specific light emitting diodes belong, as shown in FIG. 3 where three groups of light emitting diodes, G1, G2 and G3, are shown. Each group comprising n/3 light emitting diodes with n being the total number of diodes in the system. The n/3 fibers are receiving at least part of the optical output from the output of the fiber bundle A may then be bundled so as to form a specific fiber pattern. In FIGS. 3 and 4A a triangular fiber pattern is shown. The output from the fiber G1′ is known to correspond to the output from the light emitting diodes of G1, etc. Of course, the number of light emitting diodes being distributed among the groups may be differently chosen so that each group does not necessarily contain the same amount of fibers/light emitting diodes.

One or more of the groups of fibers G1, G2 and G3 may then be coupled to a delivery fiber B (not shown in FIGS. 3 and 4) either alone or in combination. If, for example, a thin fiber is necessary for a specific application and a low power laser is suitable for the said application, only light emitted from one group of transport fibers, e.g. G1, is coupled to the delivery fiber B. The light emitting diodes emitting light to transport fibers in the groups G2 and G3 are then preferably turned off or disconnected so that no excessive heat is dissipated in the system. Likewise, G2 and G3 may be connected to a delivery fiber B while G1 is disconnected, etc.

It is envisaged that also two groups of light emitting diodes may be chosen and still further, more than three groups may be used, such as for example 6, 12, 18 or even more than 20 groups may be used.

As further shown in FIG. 4A, each light emitting diode within the group may further be traceable within the specific group. Here, the fibers corresponding to a specific group of fibers are shown to be arranged in concentric circles, but of course the fibers corresponding to a specific group may be arranged in any pattern desirable for the specific use.

In FIG. 4B, the fibers corresponding to each group G1″, G2″ and G3″ are arranged in a different fiber pattern. As is seen from the figure, the fibers are arranged in concentric circles so that the fibers in a specific circle correspond to a specific group of fibers. It is, furthermore, seen from the figure that the number of fibers is different for each group. Still further, it should be noted that the distance between each of the concentric circles may be adapted to the specific application and should not be limited to the distances shown in this specific embodiment.

In order to be able to align one or more groups of fibers with respect to the delivery fiber, it is an advantage that the fibers relating to each group are arranged in concentric circles. Hereby, it is possible to choose only the center group G3″, or to choose the center group G3″ and the next group G2″, and retain the same center of the bundle of fibers. Hereby, no difficult alignment tasks are necessary when changing, for example, from a delivery fiber having a fiber diameter/brightness corresponding to the diameter/brightness of the central fiber bundle G3″ to a delivery fiber having a fiber diameter/brightness corresponding to the diameter/brightness of the fiber bundles G3″ and G2″ or G3″, G2″ and G1″.

In a preferred embodiment a number of 6×19 light emitting diodes emitting light at 810 nm is used. The light emitting diodes are then preferably grouped in three groups, each group comprising 2×19 light emitting diodes. The power output of each group of light emitting diodes is then substantially equal to 30 W, so that a low power light beam is emitted from the group G1″, where a low power light beam for the specific type of light emitting diodes corresponds to a light beam having a power less than 30 W, for the same type of light emitting diodes, a high power light beam corresponds to a light beam having a power larger than 90 W.

It is, however, envisaged that the definition of high and low power depends on the specific type of light emitting diodes used in the specific embodiment.

1. An optical fiber delivery system comprising
a number of light sources each being adapted to produce an optical light source output,
a number of first optical fibers (transport fibers) each having an input end and an output end, the input ends being adapted to be coupled to each of the number of light sources to receive the respective optical light source output, the output ends being adapted to emit an optical output, and the first optical fibers being arranged in a spatial distribution, at least at the output ends of the first optical fibers, so as to define an emitting diameter of the first optical fibers, said emitting diameter being adjustable by means of the number of first optical fibers being coupled to each of the number of light sources producing an optical output, so as to allow said emitting diameter to be adjusted to match a core diameter and an acceptance angle of a second optical fiber,
a second optical fiber (delivery fiber) having an input end and an output end, the input end of the second optical fiber being positioned so as to receive the optical output from the number of first optical fibers, and having a core diameter and acceptance cone to which the emitting diameter of the first optical fibers may be adjusted,
wherein each of the number of first optical fibers corresponds to a specific light source, so that reduction/increase of the number of light sources producing an optical output. reduces/increases the number of first optical fibers emitting an optical output so that the emitting diameter of the first optical fibers is reduced/increased so as to be adjusted to match the core diameter and acceptance cone of the second optical fiber.

2. An optical fiber delivery system according to claim 1, wherein the number of first optical fibers are bundled in a predetermined fiber pattern.

3. An optical fiber delivery system according to claim 2, wherein the predetermined fiber pattern comprises a number of concentric circles.

4. An optical fiber delivery system according to any of claims 1-3, wherein the product of the diameter of the second optical fiber and the numerical aperture of the second optical fiber is substantially equal to or larger than the product of the overall numerical aperture and the emitting diameter of a fiber bundle comprising the number of first optical fibers producing an optical output.

5. An optical fiber delivery system according to any of claims 1-4, wherein the diameter of the second optical fiber is between 0.05 mm and 2 mm.

6. An optical fiber delivery system according to any of claims 1-5, further comprising a third, fourth, fifth, or sixth optical fiber, each receiving at least part of the optical output from the bundle of first optical fibers emitting an optical output.

7. An optical fiber delivery system according to any of claims 1-6, wherein the number of light sources comprises a multi-emitter laser diode comprising a number of individual laser diodes producing an optical light source output.

8. An optical fiber delivery system according to any of claims 1-7, wherein the number of light sources comprises a number of laser diodes and/or multi-emitter laser diodes arranged in stack(s) and/or bar(s).

9. An optical fiber delivery system according to any of claims 1-8, wherein the number of light sources is larger than 10.

10. A method for delivering optical power from a number of light sources adapted to emit an optical light source output through a number of first optical fibers to a second optical fiber, the method comprising
connecting an input end of each of a number of first optical fibers to each of the number of light sources to couple the optical light source output into a respective first optical fiber, thereby defining an emitting diameter of the first optical fibers,
bundle the number of first optical fibers in a predetermined fiber pattern,
choosing a core diameter and an acceptance angle of the second optical fiber,
choosing a number of light sources to emit an optical light source output so that specific first optical fibers located at specific positions in the fiber pattern receive an optical light source output, thereby adjusting the emitting diameter of the first optical fibers to match the chosen core diameter and acceptance angle of the second optical fiber.

11. A method according to claim 10, wherein the number of light sources comprises a multi-emitter diode laser comprising a number of individual laser diodes producing an optical light source output.

12. A method according to claim 10 or 11, wherein the product of the diameter of the second optical fiber and the numerical aperture of the second optical fiber is substantially equal to or larger than the product of the overall numerical aperture and the emitting diameter of a fiber bundle comprising the number of first optical fibers producing an optical output.

13. A method according to any of claims 10-12, wherein the diameter of the second optical fiber is between 0.05 mm and 2 mm.

14. A method according to any of claims 10-13, wherein the optical power from the number of light sources may be emitted, through a number of first optical fibers, to a second and a third, fourth, fifth, or sixth optical fiber, each receiving at least part of the optical output from the bundle of first optical fibers emitting an optical output.

15. A method according to any of claims 10-14, wherein the number of light sources comprises a number of laser diodes and/or multi-emitter laser diodes arranged in stack(s) and/or bar(s).

16. A method according to any of claims 10-15, wherein the predetermined fiber pattern comprises a number of concentric circles.

17. A method according to any of claims 10-16, wherein the number of light sources is larger than 10.
